(19) United States
(12) Patent Application Publication
(10) Pub. No.: US 2010/0189756 A1
(43) Pub. Date: Jul. 29, 2010

(54) SHEET MATERIAL FOR ANTIMICROBIAL OR STERILIZING PURPOSES AND PROCESS FOR MANUFACTURING THE SAME

(76) Inventor: Takahisa Kusuura, Kawasaki-shi (JP)

Correspondence Address: FOLEY & LARDNER LLP, 150 EAST GILMAN STREET, P.O. BOX 1497, MADISON, WI, 53701-1497, US

(21) Appl. No.: 12/640,996

(22) Filed: Dec. 17, 2009

(30) Foreign Application Priority Data
Jan. 26, 2009 (JP) 2009-014252

(51) Int. Cl. A01N 25/08; B01D 39/14; A01P 1/00

(52) U.S. Cl. 424/409; 55/524

(57) ABSTRACT

To provide a material for antimicrobial or sterilizing purposes which can be used for people having delicate skin, such as babies, little children or the aged, without any trouble, which prevents viruses from acquiring tolerance, and which does not affect human bodies or foods. A sheet material for antimicrobial and/or sterilizing purposes having a surface having a plurality of indentations with a pore size of 1000 nm or less.

### CROSS REFERENCE TO RELATED APPLICATION

This application claims the benefit of Japanese Application No. 2009-14252 filed on Jan. 26, 2009 which is incorporated herein by reference.

### BACKGROUND OF THE INVENTION

1. Field of the Invention

The present application relates to a sheet material for antimicrobial or sterilizing purposes which can be used as cleaning sheets such as wet hand towels or OA product cleaners, filter materials for air purifiers, masks, and the like, or packaging materials for pharmaceuticals, foods, and the like, and a process for manufacturing the same.

2. Description of the Related Art

In recent years, with growing hygiene consciousness of people, sterilizing sheets for removing bacteria, viruses, or the like from bodies, daily necessities, and the like or antimicrobial sheets for preventing the propagation of bacteria, viruses, or the like in foods and the like have been more and more frequently used.

Known examples of such sterilizing/antimicrobial sheets include those prepared by impregnating a sheet substrate of, for example, absorbent cotton, nonwoven cloth, woven cloth or paper with a liquid chemical prepared by dissolving a chemical such as a microbicide or an antimicrobial agent in water (Japanese Patent Laid-Open No. 10-136878).

However, chemicals used in such a liquid-chemical-impregnated type of antimicrobial/sterilizing sheets present some problems. Specifically, many thereof are highly irritating to human bodies; thus, when applied to people having delicate skin, such as babies, little children or the aged, they can produce a drug rash. And, when a virus acquires tolerance to the chemical, the sheet becomes ineffective against the virus. Furthermore, for antibacterial sheets, they are often used in direct contact with foods; thus, when used for a long period time, they can affect the human bodies, cause changes in color of the foods, and spoil the flavor of the foods.

Thus, there have been demands for a material for antimicrobial and/or sterilizing purposes which can be used for people having delicate skin, such as babies, little children or the aged, without any trouble, and besides, which does not affect human bodies or foods.

### SUMMARY OF THE INVENTION

After directing tremendous research effort toward the sterilizing effect or antimicrobial effect of various materials, the present inventor has found that materials having, on a surface thereof, indentations having a pore size of nanometer-level (specifically 1000 nm or less) (hereinafter sometimes referred to as “nanopores”) have excellent antimicrobial and/or sterilizing effect. This is, the inventor speculates, because bacteria or viruses are easy to be entrapped into such nanopores, and moreover, once bacteria or viruses are entrapped into nanopores, their propagation is suppressed.

Based on these findings, the present inventor has conceived using materials having a nanoporous surface (surface on which nanopores exist) for antimicrobial and/or sterilizing purposes, and completed the present embodiments.

The present inventor also investigated a process for forming such an antimicrobial or sterilizing sheet material having a nanoporous surface. As a result, the present inventor has found that when a material which is comprised of a matrix and nanoparticles dispersed in the matrix is immersed in a liquid that dissolves the nanoparticles but not the matrix, the nanoparticles alone are selectively eluted, whereby indentations having a pore size of nanometer-level are formed on the material surface. The inventor has conceived applying this phenomenon to manufacture a sheet material for antimicrobial or sterilizing purposes which has a nanoporous surface.

### DETAILED DESCRIPTION OF THE PREFERRED EMBODIMENTS

Embodiments of the present invention will be described below, but the present invention is not limited to these embodiments. One embodiment of the present invention is a sheet material for antimicrobial or sterilizing purposes which has, on a surface thereof, a plurality of indentations having a pore size of 1000 nm or less. On the surface of the sheet material, indentations having a pore size more than 1000 nm can also exist as long as a plurality of indentations having a pore size of 1000 nm or less exist. And the pore size distribution does not necessarily need to have a peak at 1000 nm or less.

It is known that the size of viruses is generally 20 to 970 nm and mostly 300 nm or less; thus, the pore size distribution of the indentations may have a peak at from 20 nm to 1000 nm, or from 300 nm to 1000 nm, or from 500 nm to 1000 nm.

The terms “pore size of the indentations” and “pore size distribution” as used herein mean the pore diameter and pore diameter distribution determined by mercury intrusion porosimetry in compliance with JIS R1655.

The sheet material for antimicrobial or sterilizing purposes may be a sheet substrate which in itself has a nanoporous surface or may be comprised of a sheet substrate and a layer having a nanoporous surface provided on the sheet substrate. The sheet material for antimicrobial or sterilizing purposes may also be cloth which is woven of, knitting which is knitted out of, or paper which is made of a fiber having a nanoporous surface.

Next, embodiments of a process for manufacturing a sheet material for antimicrobial or sterilizing purposes according to the foregoing embodiment of the present invention will be described.

In one embodiment of the present invention, the sheet material for antimicrobial or sterilizing purposes is allowed to have a nanoporous surface, namely a surface having indentations having a pore size of nanometer level by: forming in advance a material which is comprised of a matrix and a plurality of nanoparticles dispersed in the matrix; and immersing the material in a liquid that dissolves the nanoparticles but not the matrix so that the nanoparticles alone are selectively eluted.

The material that will constitute the matrix is not limited, and which material is used can be decided appropriately depending on the applications of the sheet material. Examples of such materials include: polymer materials such as thermoplastic resins, hardening resins, elastomers and celluloses; metals such as Au, Pt and Si; oxides such as quartz and aluminum oxide; nitrides; glass; and various type of ceramics.

Specific examples of thermoplastic resins include: polyesters; polyamides; polyolefins; polycarbonates; polyimides; polystyrenes or styrene copolymers; and fluorine resins (polymers obtained by polymerizing monomers that contain fluorine atom(s) in the molecules) such as polytetrafluoroethylene (PTFE), tetrafluoroethylene-perfluoroalkoxiethylene copolymer (PFA), tetrafluoroethylene-hexafluoropropylene copolymer (FEP), tetrafluoroethylene-ethylene copolymer (ETFE), polychlorotrifluoroethylene (PCTEF), chlorotrifluoroethylene-ethylene copolymer (ECTEF), polyvinylidene fluoride and polyvinyl fluoride. Specific examples of hardening resins include epoxy resins, phenol resins, acrylic resins, and urethane resins. Specific examples of elastomers include natural rubber, styrene-butadiene copolymers and the hydrogenated products thereof.

The material that will constitute the nanoparticles is also not limited. Any material can be used as long as a liquid that dissolves the nanoparticles but not the matrix is available. For example, in cases where any one of polymer materials such as thermoplastic resins, hardening resins and elastomers, metals such as Au and Pt, and ceramics is used as the matrix, metal particles such as Ag, Cu, Fe, Ni, Cr, or Zn particles can be used as the nanoparticles. In cases where any one of celluloses, metals and ceramics is used as the matrix, particles comprised of a polymer material soluble in an organic solvent can be used as the nanoparticles.

The shape, particle size and particle size distribution of the nanoparticles are not limited. The shape and pore size of the indentations, which are traces of nanoparticles' elution, are almost the same as the shape and particle size of the nanoparticles; therefore, nanoparticles can be used which have almost the same shape, particle size and particle size distribution as the shape, pore size and pore size distribution that the surface of the indentations is desired to have. For example, the average particle size of the nanoparticles can be made from 20 nm to 1000 nm, from 300 nm to 1000 nm, or from 500 nm to 1000 nm.

The term “particle size” as used herein means the average value of two axes, namely the average value of the minor axis and the major axis observed when a particle is subjected to two-dimensional observation by a transmission electron microscope (TEM). The terms “major axis” and “minor axis” as used herein mean the long side and the short side, respectively, of the rectangle with minimum area circumscribed to the particle. The term “average particle size” as used herein means the average value of the particle size of 100 particles randomly selected from the particles observed in the same visual field when performing two-dimensional observation.

The nanoparticles may be prepared by any method.

In the material which is comprised of a matrix and a plurality of nanoparticles dispersed in the matrix, the content of the nanoparticles in the matrix is not limited. The content can be determined appropriately depending on the desired density of the pores or indentations. To elute the nanoparticles in the immersion liquid, at least a portion of the nanoparticle is exposed from the matrix. From this standpoint, the content of the nanoparticles may be, though it depends on the desired density of the indentations, 30% by volume or more, 50% by volume or more, 70% by volume or more, or 90% by volume or more, based on the total volume of the materials constituting the nanoparticles and the matrix.

In cases where the sheet material for antimicrobial or sterilizing purpose is used as a filter, the content of the nanoparticles may be high so that the nanopores can communicate with one another from one side of the sheet to the other side of the same.

In the manufacturing process according to the foregoing embodiment of the present invention, first, a material which is comprised of a matrix and nanoparticles dispersed in the matrix is formed. The material which is comprised of a matrix and nanoparticles dispersed in the matrix may be: a. a layer formed on a sheet substrate; b. a sheet substrate itself; or c. a fiber that is to be woven, knitted or made into a sheet of cloth, knitting or paper afterward.

In cases where the material which is comprised of a matrix and nanoparticles dispersed in the matrix is a. a layer formed on a sheet substrate, the process for forming the layer is not particularly limited. Further, the thickness of the layer which is made up of the material which is comprised of a matrix and nanoparticles dispersed in the matrix is not limited. The layer may have, for example, a thickness larger than or smaller than the average particle size of the nanoparticles.

According to one embodiment of the present invention, a layer made up of a material which is comprised of a matrix and nanoparticles dispersed in the matrix can be formed on a sheet substrate by: preparing a nanoparticle dispersion which comprises the material that will constitute the matrix; and applying the nanoparticle dispersion on the sheet substrate. The thickness of the layer which is comprised of a matrix and nanoparticles dispersed in the matrix is not limited. The layer may have, for example, a thickness larger than or smaller than the average particle size of the nanoparticles.

In the nanoparticle dispersion which comprises a material that will constitute the matrix, the material that will constitute the matrix may be either dissolved or dispersed in the nanoparticle dispersion. Specific examples of nanoparticle dispersions which comprise a material that will constitute the matrix include: a liquid obtained by dispersing nanoparticles in a solution in which a material that will constitute the matrix is dissolved; and a liquid obtained by dispersing both the particles comprised of a material that will constitute the matrix and the nanoparticles in a dispersion medium. For example, the nanoparticle dispersion may be prepared by: dissolving a material that will constitute the matrix in water or in an organic solvent such as an alcohol or a ketone, ester, hydrocarbon, halogenated hydrocarbon or cellulose solvent; and dispersing nanoparticles in the above solution. Alternatively, the nanoparticle dispersion may be prepared by dispersing particles comprised of a material that will constitute the matrix in a dispersion medium such as water and dispersing nanoparticles in the above dispersion. Alternatively, the nanoparticle dispersion may be prepared by dispersing nanoparticles in a dispersion medium and dispersing particles comprised of a material that will constitute the matrix in the above dispersion.

The dispersibility of nanoparticles in a dispersion may be improved by subjecting nanoparticles to surface modification which does not disturb the elution of the nanoparticles in a subsequent step. Examples of nanoparticles having undergone such surface modification include nanoparticles having a surface coated with protein or peptide or low-molecular-weight vinylpyrrolidone.

The surface modification in which protein or peptide is fixed to the surface of nanoparticles can be performed according to the method disclosed in Japanese Patent Laid-Open No. 2007-217331. Specifically, first, nanoparticles are dispersed in water using a surfactant, second, protein or peptide is added to this dispersion, and finally the dispersion is irradiated with ultrasonic waves while keeping the pH of the dispersion at 5.0 or more so that the surfactant on the surface of the nanoparticles is replaced by protein or peptide. Thus, a dispersion in water of nanoparticles with the protein or peptide fixed to their surface is obtained.

The surface modification in which nanoparticles are coated with low-molecular-weight vinylpyrrolidone can be performed according to the method disclosed in Japanese Patent Laid-Open No. 2008-121043. Specifically, nano-metal particles are prepared in the presence of low molecular-weight vinyl pyrrolidone to provide low molecular vinyl pyrrolidone-coated nano metal particles. The low molecular vinyl pyrrolidone-coated nano metal particles thus obtained are dispersed, for example, in an organic solvent such as 1, 2-ethanediol. For example, particles comprised of a material that will constitute the matrix can be further dispersed in the nanoparticle dispersion thus obtained to provide a nanoparticle dispersion which comprises a material that will constitute the matrix.

The material for the sheet substrate is not limited, and any suitable material can be selected depending on the applications for which the sheet material is used. For example, not only materials having flexibility, such as cloth, paper, nonwoven cloth or polymer film, but also materials having rigidity, such as glass sheet or ceramic sheet, can be used. Furthermore, the materials having been shown as materials for the matrix can also be used.

The method of applying a nanoparticle dispersion on a sheet substrate is not limited. For example, any one of conventionally known coating methods, such as spraying, spin coating or dip coating, can be employed.

After applying, the dispersion medium (solvent) is removed from the coating layer by drying or the like; as a result, a layer is formed which is made up of a material which is comprised of a matrix and a plurality of nanoparticles dispersed in the matrix. The coating layer may be heated, if necessary, to sinter or melt the material constituting the matrix so that the layer is changed to a firm continuous phase. In cases where the material constituting the matrix is a polymer material, the coating layer can be heated at a temperature equal to or higher than the glass transition temperature of the polymer material.

According to another embodiment of the present invention, the so-called mechanical alloying can also be used. “Mechanical alloying” means a solid mixing process for mixing two or more solids minutely while applying a high energy to the solids and causing their laminating, folding and rolling repeatedly for finely mixing. Mechanical alloying is theoretically capable of mixing solids even at the atomic level. Mechanical alloying relatively easily allows nanoparticles to be dispersed uniformly in a matrix.

Mechanical alloying is generally a process used for mixing metals. The present inventor, however, has found that the process can also be applied to mixing of materials that can undergo folding and rolling, for example, to mixing of polymer materials or mixing of polymer material(s) and metal(s) or the like.

Specifically, particles (powder) comprised of a material that will constitute the matrix and particles (powder) comprised of a material that will constitute the nanoparticles are prepared and then mixed while applying a high energy.

The solid mixture obtained by mechanical alloying can be used as it is to melt coat a substrate. Also, the solid mixture can be used in the form of a dispersion, which is prepared by dispersing the solid mixture in a suitable solvent, to coat a sheet substrate. For the method of coating with the dispersion and the sheet substrate, those mentioned above can be employed. After coating, the coating layer may be heated, if necessary, to sinter or melt the material constituting the matrix so that the layer is changed to a firm continuous phase.

In mechanical alloying, solid materials are folded and divided in the course of mixing; therefore, even if particles of nanometer-level are not prepared from the beginning, a material which is comprised of a matrix and nanoparticles dispersed in the matrix can be formed. Accordingly, the particles (powder) comprised of a material that will constitute the nanoparticles to be prepared when carrying out mechanical alloying does not need to have a particle size of nanometer-level and may have a particle size of from 1 to 1000 μm or from 1 to 100 μm. The particle size of the particles (powder) which are comprised of a material that will constitute the matrix is also not limited. The particle size thereof may be almost equal to or larger than that of the particles (powder) comprised of a material that will constitute the nanoparticles.

Mechanical alloying can be performed using a conventionally known method and apparatus which have been used for mixing metals. For example, it can be performed by mixing using a ball mill such as a rolling ball mill, an oscillating mill or a planetary ball mill. In this case, two or more solid particles are folded and rolled by the collision energy of the ball.

In cases where the material which is comprised of a matrix and nanoparticles dispersed in the matrix is b. a sheet substrate itself, neither of the process for manufacturing the material and the thickness thereof is not particularly limited. For example, the foregoing solid mixture, obtained by mechanical alloying, of particles comprised of a material that will constitute the matrix and nanoparticles can be formed into a sheet, for example by melt extrusion.

In cases where the material which is comprised of a matrix and nanoparticles dispersed in the matrix is c. a fiber, its spinning process is not limited, and any known spinning process, such as wet spinning, dry spinning or melt spinning, can be employed.

According to one embodiment of the present invention, the foregoing nanoparticle dispersion can be wet-spun. Specifically, the foregoing nanoparticle dispersion (a liquid obtained by dispersing nanoparticles in a solution in which a material that will constitute the matrix is dissolved) is spun through a nozzle into a fibrous material and the fibrous material is solidified in a solidifying solution into fiber.

According to another embodiment of the present invention, the foregoing solid mixture, obtained by mechanical alloying, of particles comprised of a material that will constitute the matrix and nanoparticles can be dry-spun. Specifically, the solid mixture is dissolved in a solvent of a material that will constitute the matrix to prepare a viscous solution, the viscous solution is then spun through a nozzle into a fibrous material, and the fibrous material is solidified into fiber by vaporizing the solvent with hot air or the like.

According to still another embodiment of the present invention, the foregoing solid mixture, obtained by mechanical alloying, of particles comprised of a material that will constitute the matrix and nanoparticles can be melt-spun. Specifically, the solid mixture is melted and spun through a nozzle into a fibrous material, and the fibrous material is cooled in the air or a gas to be solidified into fiber.

The material thus obtained, which is comprised of a matrix and nanoparticles dispersed in the matrix and in the form of: a. a layer formed on a sheet substrate; b. a sheet substrate itself; or c. fiber, is immersed in a liquid that dissolves the nanoparticles but not the matrix to elute the nanoparticles in the liquid.

In cases where the material which is comprised of a matrix and nanoparticles dispersed in the matrix is in the form of c. fiber, the fiber may be made into a sheet by knitting, weaving or paper making prior to immersion.

The liquid that dissolves the nanoparticles but not the matrix is not limited, and any suitable liquid can be selected depending on the combination of the nanoparticles and the material that will constitute the matrix. For example, an acid solution such as hydrochloric acid, nitric acid or sulfuric acid; an alkaline solution such as aqueous sodium hydroxide solution or aqueous potassium hydroxide solution; or any of various organic solvents can be used.

The immersion time is not limited, and immersion needs to be performed for a period sufficient to elute the nanoparticles. During immersion, supplementary treatment, such as irradiating the sample with ultrasonic waves, can also be performed to accelerate the elution.

After elution, the material is washed with water or subjected to some other treatment, if necessary, and then dried to provide a sheet or fiber having a nanoporous surface.

The sheet having a nanoporous surface thus obtained can be used as it is as a sheet material for antimicrobial and/or sterilizing purposes. The sheet can be also placed on some other support and used as a laminate.

Further, the sheet having a nanoporous surface thus obtained can be used as a mother die. The surface geometry of the mother die can also be transferred to some other material to manufacture a sheet material for antimicrobial and/or sterilizing purposes.

Next, an example of the procedure for manufacturing a sheet material for antimicrobial or sterilizing purposes according to one embodiment of the present invention will be described. The example is for the purpose of illustration only, and the sheet material according to the embodiment of the present invention and the process for manufacturing the same are not limited to the following procedure and the sheet material manufactured through the procedure.

A fluorine resin is prepared as a material that will constitute the matrix. The fluorine resin is added to an organic solvent and dissolved under stirring to prepare a homogenous solution. Ag particles having a particle size of nanometer-level are dispersed in the obtained solution to prepare a nanoparticle dispersion. Then, the Ag particle dispersion is applied on a sheet substrate and the coating is dried to remove the organic solvent. The sheet thus obtained having a layer comprised of a fluorine resin and a plurality of Ag particles dispersed in the fluorine resin is immersed in hydrochloric acid. After a predetermined time has elapsed, the sheet is taken out of the acid, washed with water, and dried to provide a sheet having a nanoporous surface.

It is to be understood by those skilled in the art that the selective words or phrases expressing a plurality of alternative terms, regardless of whether the words or phrases appear in the Specification, Claims or Drawings, are all intended to substantially have the potential to include: any one of the terms, either of the terms, or both of the terms. For example, the phrase “A or B” potentially means “A”, or “B”, or “A and B”.

The sheet material for antimicrobial and/or sterilizing purposes of the embodiment of the present invention can be used as a material for manufacturing various products for antimicrobial or sterilizing purposes.

The sheet material can be used for applications, for example, where the material is to be applied to people having delicate skin; where the material is to be in direct contact with human bodies or foods for a long period of time; and where the material is to be applied to precision instruments.

Specifically, the sheet material can be used as: cleaning sheets such as wet hand towels, baby wipes, cosmetic cleansing sheets, body cleaning sheets, kitchen wipers, floor cleaning wipers or OA product cleaners; filters for air purifiers, air conditioners, masks or the like; antimicrobial sheets for foods; or packaging materials for pharmaceuticals, foods or the like.

What is claimed is:

1. A sheet material for antimicrobial or sterilizing purposes having a surface having a plurality of indentations with a pore size of 1000 nm or less.

2. A cleaning sheet, comprising a sheet material according to claim 1.

3. A filter, comprising a sheet material according to claim 1.

4. A packaging material, comprising a sheet material according to claim 1.

5. A process for manufacturing a sheet material for antimicrobial or sterilizing purposes, comprising:
forming a material which is comprised of a matrix and a plurality of nanoparticles dispersed in the matrix; and
immersing the material which is comprised of a matrix and a plurality of nanoparticles dispersed in the matrix in a liquid that dissolves the nanoparticles but not the matrix.

6. The process for manufacturing a sheet material for antimicrobial or sterilizing purposes according to claim 5, wherein the nanoparticles are Ag particles.

7. The process for manufacturing a sheet material for antimicrobial or sterilizing purposes according to claim 5, wherein the matrix comprises a fluorine resin.

8. The process for manufacturing a sheet material for antimicrobial or sterilizing purposes according to claim 5, wherein the liquid that dissolves the nanoparticles but not the matrix is an alkaline solution or acid solution.

9. The process for manufacturing a sheet material for antimicrobial or sterilizing purposes according to claim 5, wherein the forming of a material which is comprised of a matrix and a plurality of nanoparticles dispersed in the matrix comprises:
preparing a sheet substrate;
preparing a nanoparticle dispersion that comprises a material that will constitute the matrix; and
applying the nanoparticle dispersion on the sheet substrate.

10. The process for manufacturing a sheet material for antimicrobial or sterilizing purposes according to claim 5, wherein the forming of a material which is comprised of a matrix and a plurality of nanoparticles dispersed in the matrix comprises:
preparing a solid mixture by mixing particles consisting of the material that will constitute the matrix and particles consisting of the material that will constitute the nanoparticles.

11. The process for manufacturing a sheet material for antimicrobial or sterilizing purposes according to claim 10, wherein the mixing is carried out using a ball mill.

12. A sheet material for antimicrobial or sterilizing purposes, which is manufactured by:
forming a material which is comprised of a matrix and a plurality of nanoparticles dispersed in the matrix; and
immersing the material which is comprised of a matrix and a plurality of nanoparticles dispersed in the matrix in a liquid that dissolves the nanoparticles but not the matrix.
